(19) United States
(12) Patent Application Publication
(10) Pub. No.: US 2014/0232332 A1
(43) Pub. Date: Aug. 21, 2014

(54) CHARGING CIRCUIT FOR AN ENERGY STORAGE DEVICE, AND METHOD FOR CHARGING AN ENERGY STORAGE DEVICE

(71) Applicant: Robert Bosch GmbH, Stuttgart (DE)

(72) Inventor: Peter Feuerstack, Ludwigsburg (DE)

(21) Appl. No.: 14/183,619

(22) Filed: Feb. 19, 2014

(30) Foreign Application Priority Data
Feb. 19, 2013 (DE) 10 2013 202 652.8

(51) Int. Cl. H02J 7/02

(52) U.S. Cl. CPC H02J 7/025
USPC 320/108; 320/162

(57) ABSTRACT

A charging circuit for an energy storage device having an inductive transmitter element designed to inductively receive a charging AC voltage. In one embodiment, a rectifier is coupled to the inductive transmitter element and designed to convert the received charging AC voltage into a charging DC voltage. The energy storage device has at least one energy supply section coupled between two output connections of the energy storage device. The energy supply section has one or more energy storage modules connected in series in the power supply section. The energy storage modules each have an energy storage cell module having at least one energy storage cell, and a coupling device having a large number of coupling elements.

### BACKGROUND OF THE INVENTION

The invention relates to a charging circuit for an energy storage device, and to a method for charging an energy storage device, in particular for charging battery direct converter circuits and battery converter circuits which are used, for example, in electrical drive systems of electrically operated vehicles.

The trend is that in the future electronic systems which combine new energy storage technologies with electrical drive technology will be increasingly used both in stationary applications, such as wind power installations or solar installations, and in vehicles, such as hybrid or electric vehicles.

A DC voltage, which is provided by a DC voltage intermediate circuit, is usually converted into a three-phase AC voltage by means of a converter in the form of a pulse-controlled inverter for the purpose of feeding three-phase alternating current to an electric machine. The DC voltage intermediate circuit is fed by a line of battery modules which are connected in series. In order to be able to meet the requirements in respect of power and energy indicated for a respective application, a plurality of battery modules are often connected in series in a traction battery. An energy storage system of this kind is often used, for example, in electrically operated vehicles.

Inductive charging systems are often used in order to charge battery modules of this kind of electrically operated vehicles. In order to be able to operate an inductive charging system with a high degree of efficiency, it is advantageous to operate the inductive transmission path as a resonant system. The output power of resonant inductive transmission paths can be varied only to a limited extent. In particular, the output voltage is proportional to the transmitted charging power within narrow limits. Specifically in the region of high end-of-charge voltages, that is to say shortly before the full state of charge is reached, battery modules can only handle a reduced power supply without suffering damage. The possible control region of the resonant inductive transmission path may not be sufficient under some circumstances in this case.

One possible way of providing compensation involves an additional direct current controller which can be inserted into the resonant inductive transmission path in order to increase the output voltage of the transmission path to the desired charging voltage when the power supply is reduced. However, this is associated with increased complexity, installation space and material usage.

U.S. Pat. No. 8,054,039 B2 discloses a method for charging a battery of an electric car, in which method the charging power can be set depending on measured operating parameters of the battery.

U.S. Pat. No. 5,642,275 A1 describes a battery system with an integrated inverter function. Systems of this kind are known by the names Multilevel Cascaded Inverter or else Battery Direct Inverter (BDI). Systems of this kind comprise direct current sources in a plurality of energy storage module sections which can be connected directly to an electrical machine or an electrical supply system. Single-phase or polyphase supply voltages can be generated in the process. In this case, the energy storage module sections have a plurality of energy storage modules which are connected in series, wherein each energy storage module has at least one battery cell and an associated controllable coupling unit which, depending on control signals, allows the respective energy storage module section to be interrupted or allows the respectively associated at least one battery cell to be bridged or allows the respectively associated at least one battery cell to be connected into the respective energy storage module section.

As alternatives, DE 10 2010 027 857 A1 and DE 10 2010 027 861 A1 disclose battery cells in energy storage devices, which battery cells are connected in a modular manner and can be selectively coupled into or decoupled from the line comprising battery cells, which are connected in series, by means of suitable actuation of coupling units. Systems of this kind are known by the name Battery Direct Converter (BDC). Systems of this kind comprise direct current sources in an energy storage module section which can be connected by means of a pulse-controlled inverter to a DC voltage intermediate circuit for supplying electrical energy to an electrical machine or to an electrical supply system.

BDCs and BDIs usually have a greater degree of efficiency and a greater level of fail-safety in comparison to conventional systems. The level of fail-safety is ensured, amongst other things, in that battery cells which are defective, have broken down or are not capable of full power can be disconnected from the energy supply sections by suitable bridging actuation of the coupling units.

### SUMMARY OF THE INVENTION

According to one embodiment, the present invention provides a charging circuit for an energy storage device comprising an inductive transmitter element which is designed to inductively receive a charging AC voltage, a rectifier which is coupled to the inductive transmitter element and which is designed to convert the received charging AC voltage into a charging DC voltage, and an energy storage device. The energy storage device has at least one energy supply section which is coupled between two output connections of the energy storage device. The energy supply section has one or more energy storage modules which are connected in series in the power supply section. The energy storage modules each have an energy storage cell module having at least one energy storage cell, and a coupling device having a large number of coupling elements, which coupling device is designed selectively to connect the energy storage cell module into the respective energy supply section or to bypass the energy storage cell module in said energy supply section. In this case, the rectifier is coupled directly to the output connections of the energy storage device, and the energy storage device has a control device which is designed to actuate the coupling devices of the energy storage modules depending on the state of charge of the associated energy storage cells using the rectifier in a charging mode of the energy storage device.

According to a further embodiment, the present invention provides a method for charging an energy storage device, comprising the steps of inductively receiving a charging AC voltage by way of an inductive transmitter element, of converting the received charging AC voltage into a charging DC voltage by way of a rectifier, of determining the state of charge of energy storage cells of an energy storage device having at least one energy supply section which is coupled between two output connections of the energy storage device, and of setting an output voltage of the energy supply section by actuating the coupling devices of the energy storage modules depending on the determined state of charge of the energy storage cells. In this case, the energy supply section has one or more energy storage modules which are connected in series in the energy supply section and which each have an energy storage cell module having at least one energy storage cell, and a coupling device having a large number of coupling elements, which coupling device is designed selectively to connect the energy storage cell module into the respective energy supply section or to bypass the energy storage cell module in said energy supply section,

One idea of the present invention is to use an energy storage device having energy supply sections of modular construction comprising a series circuit of energy storage modules to supply an electrical drive system, wherein the energy storage modules each have energy storage cells which can be connected into or disconnected from the energy supply section. As a result, the output voltage of the energy storage device can be matched to the charging power of a rectifier.

This is particularly advantageous when the energy storage cells are intended to be charged close to their final state of charge: in this region, the number of energy storage cells which are to be charged in each case simultaneously can be successively reduced in order to not depart from the optimum control region of the supplying rectifier.

By virtue of using this control strategy, it is possible to dispense with an additional direct current controller in the inductive power transmission path, this reducing installation space, manufacturing costs and power losses during operation. In addition, less cooling power is required for the power electronics. In particular, the range of variation in possible design variants can also be reduced in this way, as a result of which the system topology is simplified. Whereas, for example in hybrid vehicles, voltage levels in the range of between 150 V and 300 V are typically required, electric vehicles operate with higher voltage levels in the range of between 250 V and 450 V. By virtue of adapting the output voltage in the energy storage device, the same charging circuit can be used both in hybrid vehicles and also in purely electric vehicles, without fundamental changes having to be made to the design of the inductive transmission paths of the charging circuit in the process.

According to one embodiment of the charging circuit according to the invention, the coupling devices can each have a large number of coupling elements in a full-bridge circuit. As an alternative, the coupling devices can each have a large number of coupling elements in a half-bridge circuit.

According to a further embodiment of the charging circuit according to the invention, the at least one energy storage cell can have a lithium-ion rechargeable battery.

According to a further embodiment of the charging circuit according to the invention, the charging circuit can have a DC voltage intermediate circuit which is coupled between the output connections of the energy storage device. This advantageously makes it possible to reduce fluctuations in voltage or current in the output voltage or in the input current of the energy storage device in the charging mode, in particular when one or more of the energy storage modules are actuated in a pulse-width-modulated manner.

According to one embodiment of the method according to the invention, actuating the coupling devices of the energy storage modules can comprise selectively connecting or disconnecting the energy storage cell modules into/from the respective energy supply section. Furthermore, the method can further exhibit the step of cyclically exchanging the energy storage cell modules which are connected into the respective energy supply section. As a result, it is advantageously possible to ensure that the same charging power is applied to the energy storage cells on average over time.

In this case, it is possible, in a further embodiment of the method according to the invention, to determine the number of energy storage cell modules which are connected into the respective energy supply section depending on the determined state of charge of the energy storage cells. As a result, it is possible to ensure that a maximum output voltage of the energy supply section is not exceeded when the state of charge of the individual energy storage cells increases over the course of the charging process. This permits an optimum control range for the rectifier, without the charging power for the energy storage device or the energy storage cells becoming excessively high.

### BRIEF DESCRIPTION OF THE DRAWINGS

Further features and advantages of embodiments of the invention can be found in the following description with reference to the appended drawings.

In the drawings:

FIG. 1 shows a schematic illustration of an energy storage device according to one embodiment of the present invention;

FIG. 2 shows a schematic illustration of an exemplary embodiment of an energy storage module of an energy storage device according to a further embodiment of the present invention;

FIG. 3 shows a schematic illustration of a further exemplary embodiment of an energy storage module of an energy storage device according to a further embodiment of the present invention;

FIG. 4 shows a schematic illustration of a further energy storage device according to a further embodiment of the present invention;

FIG. 5 shows a schematic illustration of a method for charging an energy storage device according to a further embodiment of the present invention;

FIG. 6 shows a schematic illustration of a charging circuit for an energy storage device according to a further embodiment of the present invention; and

FIG. 7 shows a schematic illustration of a further charging circuit for an energy storage device according to a further embodiment of the present invention.

### DETAILED DESCRIPTION

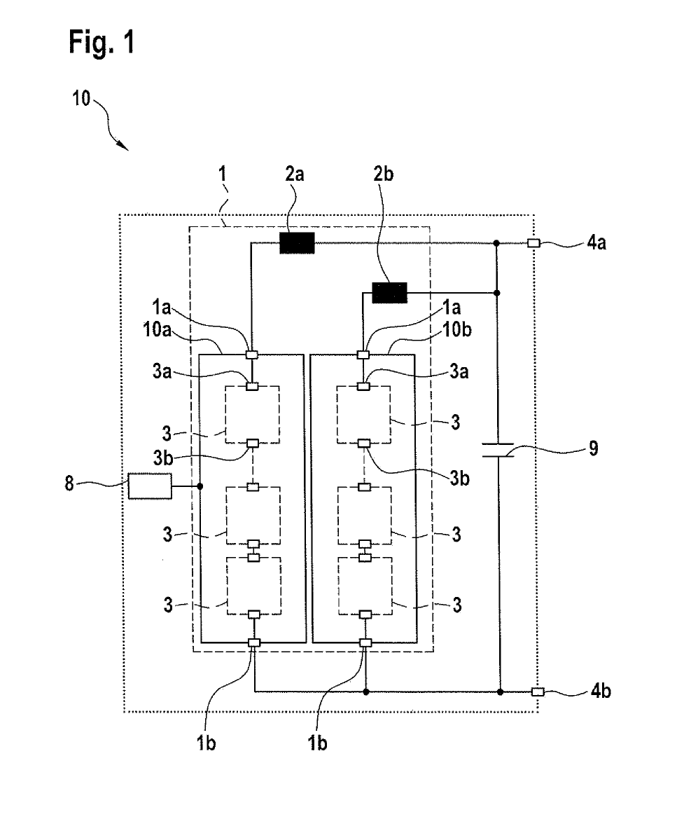

FIG. 1 shows an energy storage device 10 having a battery module 1 for providing a supply voltage by energy supply sections 10a, 10b, which can be connected in parallel, between two output connections 4a and 4b of the energy storage device 10. The energy supply sections 10a, 10b each have section connections 1a and 1b. The energy storage device 10 has at least two energy supply sections 10a, 10b which are connected in parallel. The number of energy supply sections 10a, 10b in FIG. 1 is, by way of example, two, but any other larger number of energy supply sections 10a, 10b is likewise possible. In this case, it is equally also possible to connect only one energy supply section 10a between the section connections 1a and 1b, said section connections forming the output connections 4a, 4b of the energy storage device 10 in this case.

In this case, the energy supply sections 10a, 10b can be coupled to the output connection 4a of the energy storage device 10 by means of storage inductances 2a, 2b in each case. The storage inductances 2a, 2b can be, for example, concentrated or distributed components. As an alternative, it is also possible to use parasitic inductances of the energy supply sections 10a, 10b as storage inductances 2a, 2b.

In the case of an individual energy supply section 10a, the storage inductances 2a and 2b can also be dispensed with, with the result that the energy supply section 10a is coupled directly between the output connections 4a, 4b of the energy storage device 10.

Each of the energy supply sections 10a, 10b has at least two energy storage modules 3 which are connected in series. The number of energy storage modules 3 per energy supply section in FIG. 1 is, by way of example, two, but any other number of energy storage modules 3 is likewise possible. In this case, each of the energy supply sections 10a, 10b preferably comprises the same number of energy storage modules 3, but it is also possible to provide a different number of energy storage modules 3 for each energy supply section 10a, 10b. The energy storage modules 3 each have two output connections 3a and 3b by means of which an output voltage of the energy storage modules 3 can be provided.

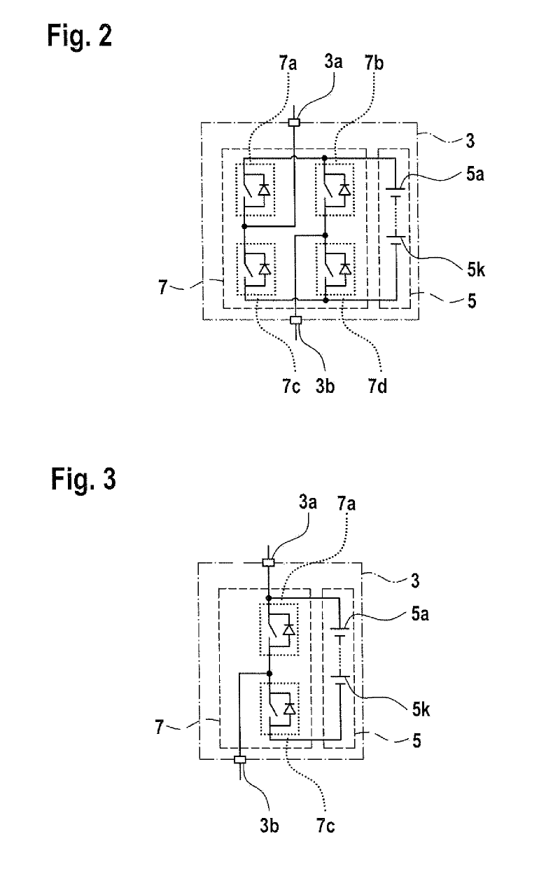

Exemplary design embodiments of the energy storage modules 3 are shown in greater detail in FIGS. 2 and 3. The energy storage modules 3 each comprise a coupling device 7 with a plurality of coupling elements 7a and 7c and also possibly 7b and 7d. Furthermore, the energy storage modules 3 each comprise an energy storage cell module 5 with one or more energy storage cells 5a to 5k which are connected in series.

In this case, the energy storage cell module 5 can have, for example, batteries 5a to 5k which are connected in series, for example lithium-ion batteries or lithium-ion rechargeable batteries. In this case, the number of energy storage cells 5a to 5k in the energy storage module 3 which is shown in FIG. 2 is, by way of example, two, but any other number of energy storage cells 5a to 5k is likewise possible.

The energy storage cell modules 5 are connected to the input connections of an associated coupling device 7. The coupling device 7 is, by way of example, in the form of a full-bridge circuit with in each case two coupling elements 7a, 7c and two coupling elements 7b, 7d in FIG. 2. In this case, the coupling elements 7a, 7b, 7c, 7d can each have an active switching element, for example a semiconductor switch, and a freewheeling diode which is connected in parallel with said active switching element. The semiconductor switches can have, for example, field-effect transistors (FETs) or bipolar transistors with an insulated gate (IGBTs). In this case, the freewheeling diodes can each also be integrated in the semiconductor switches.

The coupling elements 7a, 7b, 7c, 7d in FIG. 2 can be actuated in such a way, for example with the aid of the control device 8 in FIG. 1, that the energy storage cell module 5 is selectively switched between the output connections 3a and 3b, or that the energy storage cell module 5 is bridged or bypassed. Therefore, individual energy storage modules 3 can be integrated into the series circuit of an energy supply section 10a, 10b in a targeted manner by virtue of suitable actuation of the coupling devices 7.

With reference to FIG. 2, the energy storage cell module 5 can be connected, for example in the forward direction, between the output connections 3a and 3b by virtue of the active switching element of the coupling element 7d and the active switching element of the coupling element 7a being moved to a closed state, while the two remaining active switching elements of the coupling elements 7b and 7c are moved to an open state. In this case, there is a positive module voltage between the output terminals 3a and 3b of the coupling device 7. A bridging state can be set, for example, by virtue of the two active switching elements of the coupling elements 7a and 7b being moved to the closed state, while the two active switching elements of the coupling elements 7c and 7d are held in the open state. A second bridging state can be set, for example, by virtue of the two active switches of the coupling elements 7c and 7d being moved to the closed state, while the active switching elements of the coupling elements 7a and 7b are held in the open state. In both bridging states, there is the voltage of 0 between the two output terminals 3a and 3b of the coupling device 7. Similarly, the energy storage cell module 5 can be connected in the backward direction between the output connections 3a and 3b of the coupling device 7 by virtue of the active switching elements of the coupling elements 7b and 7c being moved to the closed state, while the active switching elements of the coupling elements 7a and 7d are moved to the open state. In this case, there is a negative module voltage between the two output terminals 3a and 3b of the coupling device 7.

In this case, the total output voltage of an energy supply section 10a, 10b can be set in stages in each case, wherein the number of stages is scaled with the number of energy storage modules 3. When there is a number of n first and second energy storage modules 3, the total output voltage of the energy supply section 10a, 10b can be set in 2n+1 stages.

FIG. 3 shows a further exemplary embodiment of an energy storage module 3. The energy storage module 3 shown in FIG. 3 differs from the energy storage module 3 which is shown in FIG. 2 only in that the coupling device 7 has two rather than four coupling elements, and said coupling elements are connected in a half-bridge circuit instead of in a full-bridge circuit.

In the illustrated design variant, the active switching elements can be designed as power semiconductor switches, for example in the form of IGBTs (Insulated Gate Bipolar Transistors), JFETs (Junction Field-Effect Transistors) or as MOSFETs (Metal Oxide Semiconductor Field-Effect Transistors).

The coupling elements 7a, 7b, 7c, 7d of an energy storage module 3 can also be actuated in a pulsed manner, for example in a pulse-width-modulation (PWM) process, with the result that the energy storage module 3 in question delivers, on average over time, a module voltage which can have a value of between zero and the maximum possible module voltage which is determined by the energy storage cells 5a to 5k. In this case, actuation of the coupling elements 7a, 7b, 7c, 7d can be performed by, for example, a control device, like the control device 8 in FIG. 1, which is designed to carry out, for example, current regulation with subordinate voltage control, with the result that individual energy storage modules 3 can be connected and disconnected in stages.

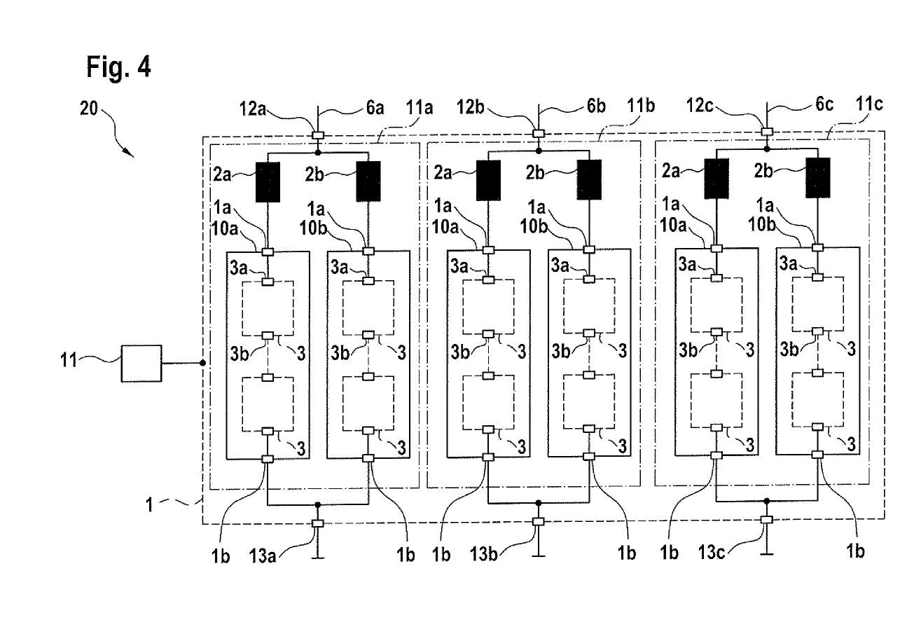

FIG. 4 shows an energy storage device 20 with a battery module 1 for converting voltage from DC voltage which is provided by energy storage modules 3 into an n-phase AC voltage. The energy storage device 20 comprises energy storage modules 3 which are connected in series with energy supply sections 10a, 10b, which are connected in parallel, in energy supply branches 11a, 11b, 11c. Three energy supply branches 11a, 11b, 11c, which are suitable for generating a three-phase AC voltage, for example for a three-phase machine, are shown by way of example in FIG. 4. However, it is clear that any other number of energy supply branches can likewise be possible. The energy storage device 20 has an output connection 12a, 12b, 12c on each energy supply branch.

The energy supply branches 11a, 11b, 11c are each connected, at their end, to output connections 13a, 13b and 13c which, for their part, can be connected to a reference potential for example. Each of the energy supply branches 11a, 11b, 11c has two energy supply sections 10a, 10b which are connected in parallel. The number of energy supply sections 10a, 10b per energy supply branch is, by way of example, two in FIG. 4, but any other number of energy supply sections 10a, 10b is likewise possible. In this case, each of the energy supply branches 11a, 11b, 11c preferably comprises the same number of energy supply sections 10a, 10b, but it is also possible to provide a different number of energy supply sections 10a, 10b for each energy supply branch 11a, 11b, 11c. The energy supply sections 10a, 10b of each energy supply branch 11a, 11b, 11c can be coupled to the respective output connections 12a, 12b, 12c by means of storage inductances 2a, 2b. In particular, it may also be possible to provide only one energy supply section 10a in each of the energy supply branches 11a, 11b, 11c. In this case, the storage inductances 2a, 2b can also be dispensed with.

The energy storage modules 3 of the energy storage device 20 in FIG. 4 can be designed, in particular, according to one of the exemplary embodiments of FIGS. 2 and 3, and therefore the energy supply branches 11a, 11b, 11c can be designed in a modular manner from a combined parallel and series circuit of similar energy storage modules 3. Similarly to in FIG. 1, actuation of the coupling devices 7 can be performed by a control device 11 of the energy storage device 20 in this case.

FIG. 6 shows a schematic illustration of a charging circuit 100 which has an energy storage device 10 according to FIG. 1. In this case, the charging circuit 100 comprises an inductive transmitter element 24b which is designed to inductively receive a charging AC voltage. The inductive transmitter element 24b can, for example, have a corresponding inductive coupling mating piece 24a. The transmitter element 24b and also the coupling mating piece 24a can comprise inductances for example. In this case, a magnetic alternating field is generated in the coupling mating piece 24a, said magnetic alternating field being generated by a transmitter coil through which an alternating current flows. The magnetic alternating field of the coupling mating piece 24a passes through at least part of a receiver coil in the transmitter element 24b, as a result of which a charging AC voltage is induced in the receiver coil. On account of the induced charging AC voltage, power is transmitted when current is correspondingly discharged from the receiver coil. Therefore, the transmitter element 24b and the coupling mating piece 24a together form a coupling-connection device which represents a transformer with two circuits which are DC-isolated from one another.

The coupling mating piece 24a is fed by an energy supply system or another AC voltage source which can be connected to the charging circuit 100 by means of a plug 21. In this case, the AC voltage of the energy supply system or the AC voltage source can be output to a transmitter actuation means 23, which has an inverter, by means of a power factor correction stage and/or an input rectifier 22. The inverter of the transmitter actuation means 23 serves to control the transmission path of the charging circuit 100 in a resonant mode.

The transmitter element 24b feeds a rectifier 25 which is coupled to the inductive transmitter element 24b and which is designed to convert the received charging AC voltage into a charging DC voltage. The rectifier 25 can, for example, additionally have components which carry out power compensation. In this case, the transmitted charging power of the charging circuit at the rectifier 25 is scaled in proportion to the charging voltage which is output by the rectifier 25.

In this case, the rectifier 25 is coupled directly to the output connections 4a, 4b of the energy storage device 10. In this connection, directly means that there is no other active current control element, in particular no DC voltage converter, interposed between the rectifier 25 and the energy storage device 10. However, it may be possible in this case to provide switching elements, such as relays or the like, between the rectifier 25 and the energy storage device 10 in order to temporarily decouple the rectifier 25 from the energy storage device 10. Therefore, the rectifier 25 is directly connected to the energy storage device 10 at least during a charging mode of the energy storage device 10.

The output connections 4a, 4b of the energy storage device 10 can also be connected to a DC voltage intermediate circuit 26. In the exemplary embodiment in FIG. 6, the DC voltage intermediate circuit 26 feeds an inverter 27, which is in the form of a pulse-controlled inverter and which provides a three-phase AC voltage for an electrical machine 28 from the DC voltage of the DC voltage intermediate circuit 26. However, it is also possible for any other type of converter to be used for the inverter 27, depending on the required voltage supply for the electrical machine 28, for example a DC voltage converter. The inverter 27 can be operated, for example, in a space vector pulse-width-modulation (SVPWM) process.

By way of example, the inverter 27 in FIG. 6 serves to feed a three-phrase electrical machine 28. However, provision can also be made for the energy storage device 10 to be used for generating an electric current for an energy supply system. As an alternative, the electrical machine 28 can also be a synchronous or asynchronous machine, a reluctance machine or a brushless DC motor (BLDC). In this case, it may also be possible to use the energy storage device 10 in stationary systems, for example in power stations, in electrical energy generation plants, such as wind power installations, photovoltaic installations or combined heat and power generation plants for example, in energy storage installations, such as compressed-air storage power stations, battery storage power stations, flywheel energy stores, pumped-storage facilities or similar systems for example. A further possible use of the charging circuit 100 in FIG. 6 is in passenger or goods transportation vehicles which are designed for locomotion on or beneath the water, for example ships, motor boats or the like.

FIG. 7 shows a schematic illustration of a charging circuit 200 which has an energy storage device 20 as is shown in FIG. 4. The charging circuit 200 differs from the charging circuit 100 which is shown in FIG. 6 substantially in that the rectifier 25 directly feeds the energy storage device 20 by means of the output connection pairs 12a and 13a, 12b and 13b, and also 12c and 13c. In this case, the energy storage device 20 has an integrated inverter functionality, with the result that the output connections 13a, 13b and 13c can be connected directly to phase lines of the three-phase electrical machine 28. However, the same principles as for the energy storage device 10 in FIG. 6 apply for feeding the individual energy supply branches 11a, 11b and 11c of the energy storage device 20—as explained in the text which follows.

The profile of the output voltage of a power supply section 10a, 10b rises continuously with the state of charge of the energy storage cells 5a to 5k which are present in the energy supply section, that is to say the higher the state of charge of the energy storage cells 5a to 5k, the greater the output voltage which is required for charging. ely in the case of lithium-ion rechargeable batteries as energy storage cells 5a to 5k, the cell voltage varies from approximately 3 V, in the fully discharged state, up to approximately 4.1 volts in the fully charged state. Accordingly, the total output voltage of a power supply section 10a, 10b with a number of eight energy storage modules 3 with in each case 12 energy storage cells 5a to 5k varies in a range of between 290 V and 390 V.

The charging circuit 100 or 200 can be operated at a high charging current and associated output voltage in the state of low charge. For example, the output range of the charging DC voltage can be between approximately 260 V and approximately 320 V. As long as the state of charge of the energy storage cells 5a to 5k is below a charging threshold value, the charging circuit 100 or 200 can charge all of the energy storage cells 5a to 5k simultaneously.

When the charging threshold value for the state of charge of the energy storage cells 5a to 5k is exceeded, all of the energy storage cells 5a to 5k or all of the energy storage modules 3 are no longer charged simultaneously. For example, a number M of energy storage modules 3 from amongst the number N of energy storage modules 3 of an energy supply section 10a, 10b can be temporarily excluded from the simultaneous charging mode. The number M can be =1, for example. In order that the energy storage modules 3 which are temporarily excluded from the charging mode can nevertheless be charged at the same time, provision can be made for the energy storage modules 3 which are involved in the charging mode to be cyclically exchanged over all N energy storage modules 3. All of the energy storage modules 3 are then charged uniformly on average over time, wherein the total output voltage of the energy supply sections 10a, 10b is reduced compared to the connection of all N energy storage modules 3. As a result, the charging voltage can again be kept below the charging threshold value.

Each time the charging voltage again exceeds the charging threshold value as the state of charge of the energy storage cells 5a to 5k continues to rise, the number M of energy storage modules 3 which are not connected can be increased, for example in integer increments. The cyclical replacement of the N-M energy storage modules 3 which are temporarily involved in the charging operation can once again be adjusted.

By virtue of adjusting the number of energy storage modules 3 which are simultaneously involved in the charging operation, the charging voltage can always be kept within a predefined charging voltage range. In this case, said charging voltage range can preferably be matched to the optimum control range of the inductive transmission path of the charging circuit 100 or 200. If adjustment of the number of energy storage modules 3 in stages is not sufficient, individual energy storage modules 3 can also be actuated in a pulse-width-modulation (PWM) process in order to be able to set intermediate values for the output voltage. As a result, the same charging circuit topology can be used for different types of battery without substantial changes having to be made to the components of the transmission path. Rather, the charging voltage is adjusted by suitable actuation of the energy storage device 10 or 20 by virtue of the selection of the chronology of the energy storage modules 3 which are to be charged being correspondingly selected.

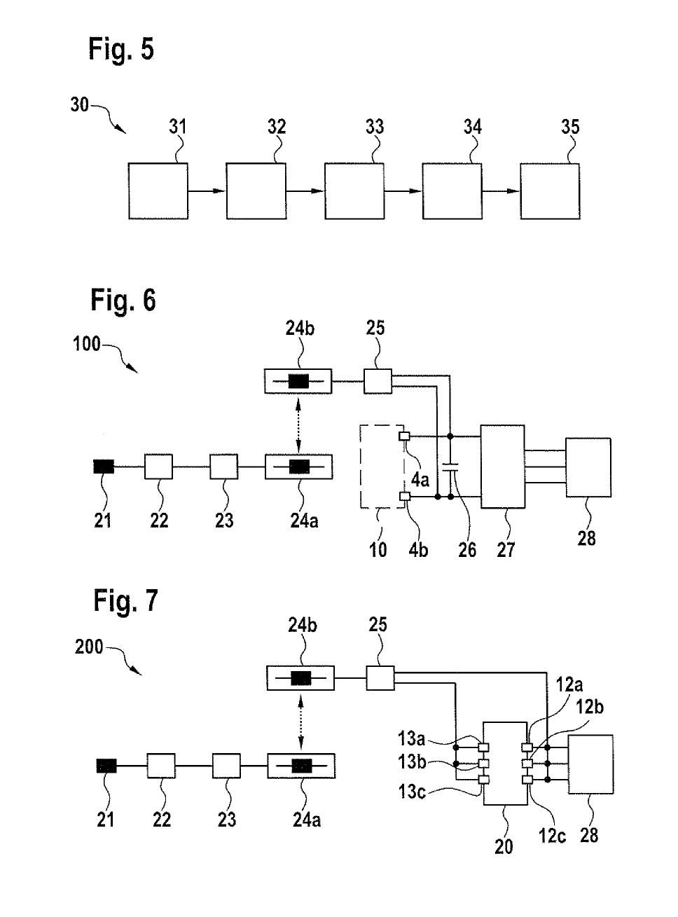

In this case, FIG. 5 shows a schematic illustration of an exemplary method 30 for charging an energy storage device, in particular an energy storage device 10 or 20, as explained in connection with FIGS. 1 to 4 and 6 to 7. In a first step 31, a charging AC voltage is inductively received by an inductive transmitter element 24b. The received charging AC voltage can be converted into a charging DC voltage in a second step 32, for example by way of a rectifier 25.

Then, in a step 33, the state of charge of energy storage cells 5a to 5k of the energy storage device 10 or 20, as explained in connection with FIGS. 1 to 4 and 6 to 7 is determined. Finally, in a step 34, an output voltage of the energy supply section 10a, 10b can be set by actuating the coupling devices 7 of the energy storage modules 3 depending on the determined state of charge of the energy storage cells 5a to 5k.

In this case, actuation of the coupling devices 7 of the energy storage modules 3 can comprise selective connection or disconnection of the energy storage cell modules 5 into/from the respective energy supply section 10a, 10b. In this case, the method 30 can optionally also comprise the step 35 of cyclically exchanging the energy storage cell modules 5 which are connected into the respective energy supply section 10a, 10b, wherein the number of energy storage cell modules 5 which are connected into the respective energy supply section 10a, 10b is determined depending on the determined state of charge of the energy storage cells 5a, 5k.

1. A charging circuit for an energy storage device, the charging circuit comprising:
an inductive transmitter element which is designed to inductively receive a charging AC voltage;
a rectifier which is coupled to the inductive transmitter element and which is designed to convert the received charging AC voltage into a charging DC voltage; and
an energy storage device having at least one energy supply section which is coupled between two output connections of the energy storage device, wherein the energy supply section has:
one or more energy storage modules which are connected in series in the energy supply section and which each have:
an energy storage cell module having at least one energy storage cell ; and
a coupling device having a large number of coupling elements , which coupling device is designed selectively to connect the energy storage cell module into the respective energy supply section or to bypass the energy storage cell module in said energy supply section,
wherein the rectifier is coupled directly to the output connections of the energy storage device, and
wherein the energy storage device has a control device which is designed to actuate the coupling devices of the energy storage modules as a function of the state of charge of the associated energy storage cells using the rectifier in a charging mode of the energy storage device.

2. The charging circuit according to claim 1, wherein the coupling devices each have a large number of coupling elements in a full-bridge circuit.

3. The charging circuit according to claim 1, wherein the coupling devices each have a large number of coupling elements in a half-bridge circuit.

4. The charging circuit according to claim 1, wherein the at least one energy storage cell has a lithium-ion rechargeable battery.

5. The charging circuit (100) according to claim 1, further comprising:
a DC voltage intermediate circuit which is coupled between the output connections of the energy storage device.

6. A method for charging an energy storage device, the method comprising:
inductively receiving a charging AC voltage by way of an inductive transmitter element;
converting the received charging AC voltage into a charging DC voltage by way of a rectifier;
determining the state of charge of energy storage cells of an energy storage device having at least one energy supply section which is coupled between two output connections of the energy storage device, wherein the energy supply section has:
one or more energy storage modules which are connected in series in the energy supply section and which each have:
an energy storage cell module having at least one energy storage cell; and
a coupling device having a large number of coupling elements, which coupling device is designed selectively to connect the energy storage cell module into the respective energy supply section or to bypass the energy storage cell module in said energy supply section, and
setting an output voltage of the energy supply section by actuating the coupling devices of the energy storage modules depending on the determined state of charge of the energy storage cells.

7. The method according to claim 6, wherein actuating the coupling devices of the energy storage modules comprises selectively connecting or disconnecting the energy storage cell modules into/from the respective energy supply section,
and wherein the method further exhibits the step of:
cyclically exchanging the energy storage cell modules which are connected into the respective energy supply section.

8. The method according to claim 7, wherein the number of energy storage cell modules which are connected into the respective energy supply section is determined depending on the determined state of charge of the energy storage cells.
